(19) United States
(12) Patent Application Publication
(10) Pub. No.: US 2026/0296519 A1
(43) Pub. Date: Oct. 1, 2026

(54) ROCKING DEVICE

(71) Applicant: NURTIA LIMITED, Dublin (IE)

(72) Inventor: Manuel NOVARO, Sospel (FR)

(21) Appl. No.: 19/478,783

(22) PCT Filed: Apr. 24, 2023
(86) PCT No.: PCT/EP2023/060672

§ 371 Date: Oct. 24, 2025

(51) Int. Cl. B62B 9/22; A47D 7/00; A47D 15/00; B62B 7/12

(52) U.S. Cl. CPC B62B 9/22; B62B 7/12; A47D 7/00; A47D 15/00

(57) ABSTRACT

A rocking device suitable for rocking a stroller includes a housing assembly containing an electrical drive mechanism and an electrical power supply and that is provided with gripping means suitable to grip a portion of a stroller. The housing assembly consisting of at least two parts extending along a main axis including a base part for placing the rocking device on the ground, and a movable part which is mounted on the base part so as to be movable with respect to the base part, according to an oscillatory movement imparted by the electrical drive mechanism. The movable part includes a rest position where the movable part is substantially aligned with the base part, at least one extreme position where the movable part is shifted from the base part, such that the oscillatory movement provokes alternate displacement of the movable part between the rest position and the extreme position.

### TECHNICAL FIELD OF THE INVENTION

The present invention relates to a rocking device suitable for rocking a stroller or other devices for babies.

### TECHNICAL BACKGROUND

There are several types of rocking devices for stroller that can create a back-and-forth movement and reproduce the manual action of the parents to create this movement that almost instinctively soothes the infant, from birth to the age of three.

However, existing devices are often interfaced with a wheel of the stroller which compromises the stability of the stroller.

Moreover, existing devices are not compact and are cumbersome to transport.

### SUMMARY OF THE INVENTION

The invention proposes a rocking device suitable for rocking a stroller, said rocking device comprising a housing assembly which contains an electrical drive mechanism and an electrical power supply, and which is provided with gripping means suitable to grip a portion of a stroller,
said housing assembly consisting of at least two parts extending along a main axis:
   a base part for placing the rocking device on the ground in a stable manner,
   a movable part which is mounted on the base part so as to be movable with respect to the base part, along a longitudinal translation direction which is substantially perpendicular to the main axis, according to an oscillatory movement imparted by the electrical drive mechanism,
said movable part comprising:
   a rest position wherein the movable part is substantially aligned with the base part along the main axis,
   at least one extreme position wherein the movable part is shifted from the base part along the longitudinal direction,
such that said oscillatory movement provoke alternate displacement of the movable part between the rest position and the at least one extreme position.

According to other features of the invention:
the housing assembly comprises at least one rail extending in the translation direction allowing a sliding movement of the movable part in relation to the base part;
the housing assembly comprises a sliding block and two stages of rails extending in the longitudinal translation direction among which:
   a first stage with two bottom rails arranged in the base part, the sliding block comprising a bottom guiding part interfaced with the bottom rails, and
   a second stage with two top rails arranged in the movable part, the sliding block comprising a top guiding part interfaced with the top rails 33;
the electrical drive mechanism comprises:
   a rotary electric motor, and
   a connecting rod comprising a proximal end connected to the motor and a distal end connected to the housing assembly;
the housing assembly comprises a slideway and the distal end of the connected rod comprises a pin inserted in the slideway;
the rocking device is such that:
   the motor rotation axis is transversal, and
   the slideway is vertical;
the gripping means comprise a slot extending transversally across the top of the housing to receive a portion of the stroller;
the gripping means also comprise retaining means comprising a cleat pivotally movable about a vertical cleat axis between a retracted position and a retaining position in which the cleat is pivoted above the slot in order to secure the rocking device to the stroller;
the gripping means comprise a nut for attaching an attachment element to the frame of a stroller;
the housing assembly also comprises a telescopic part, the gripping means being mounted on the telescopic part;
the telescopic part is mounted so as to be able to slide with respect to the movable part along the main axis;
the rocking device is such that:
   the telescopic part comprises at least one vertically extending toothed rail,
   the movable part comprises at least one crank driving in rotation a toothed wheel cooperating with the toothed rail.
the base part comprises a stabilizing element with respect to the ground;
the stabilizing element comprises at least three legs;
the legs are retractable.

### BRIEF DESCRIPTION OF THE FIGURES

Further features and advantages of the invention will become apparent from the following detailed description, for the understanding of which reference is made to the attached drawings in which:

FIG. 1 is a general view of a stroller equipped with a rocking device according to the invention;

FIG. 2 is a perspective view showing the rocking device in a rest position of the movable part;

FIG. 3 is a schematic top view showing a stroller equipped with a rocking device according to the invention in a rest position of the movable part;

FIG. 4 is a schematic top view showing the stroller of FIG. 3 in a forward extreme position of the movable part;

FIG. 5 is a schematic top view showing the stroller of FIG. 3 in a backward extreme position of the movable part;

FIG. 6 is an exploded view showing the various parts of the rocking device according to an embodiment;

FIG. 7 is a front view showing the rocking device of FIG. 6 once assembled;

FIG. 8 is a schematic right-side view showing the rocking device of FIG. 6 in a rest position of the movable part;

FIG. 9 is a schematic right-side view showing the rocking device of FIG. 6 in a forward extreme position of the movable part;

FIG. 10 is a schematic right-side view showing the rocking device of FIG. 6 in a backward extreme position of the movable part;

FIG. 11 is a schematic left-side view showing the rocking device of FIG. 6 in a rest position of the movable part;

FIG. 12 is a schematic left-side view showing the rocking device of FIG. 6 in a forward extreme position of the movable part;

FIG. 13 is a schematic left-side view showing the rocking device of FIG. 6 in a backward extreme position of the movable part;

FIG. 14 is a schematic front view in a vertical section of the rocking device according to another embodiment showing an example of height adjustment of the telescopic part in relation to the movable part;

FIG. 15 is a detailed view showing an example of telescopic part suitable for receiving an attachment element to secure the rocking device to a stroller;

FIG. 16 is a general view showing a stroller equipped with a rocking device by means of the attachment element of FIG. 15;

FIG. 17 is a general view showing another use case in which a crib is equipped with a rocking device according to the invention.

### DETAILED DESCRIPTION OF THE INVENTION

For the description of the invention and the understanding of the claims, the vertical, longitudinal and transverse orientations according to the reference frame V, L, T shown in the figures, whose longitudinal L and transverse T axes extend in a horizontal plane, will be adopted as non-limiting and without restrictive reference to terrestrial gravity. By convention, the longitudinal axis L is oriented from back to front, the transversal axis T is oriented from right to left and the vertical axis V is oriented from bottom to top.

In the following description, identical, similar or analogous elements will be referred to by the same reference numbers.

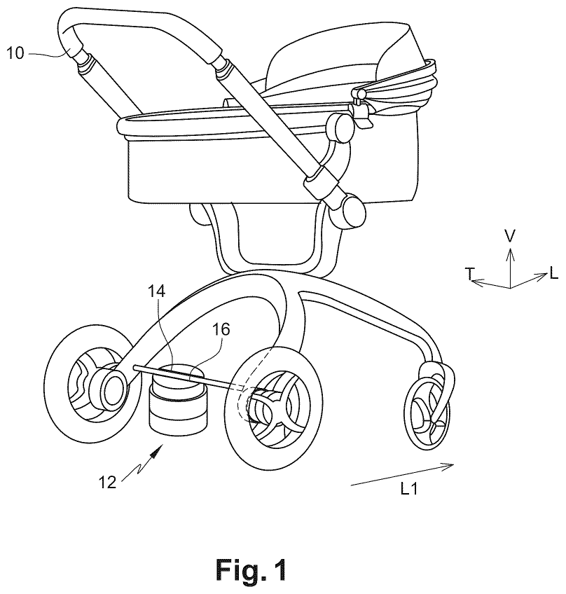

FIG. 1 illustrates a stroller 10 equipped with a transportable rocking device 12 according to the invention. The rocking device 12 is set on the ground and is fixed through gripping means 14 to a portion of the stroller 10, for example to the stroller axle 16. In an operating state of the device, the rocking device 12 imparts an oscillatory movement from back to front to the stroller 10 along a longitudinal translation direction L1.

The rocking device 12 is also suitable for rocking other devices for babies such as a crib, a maxi-cosy or a baby car seat, or a recliner crib.

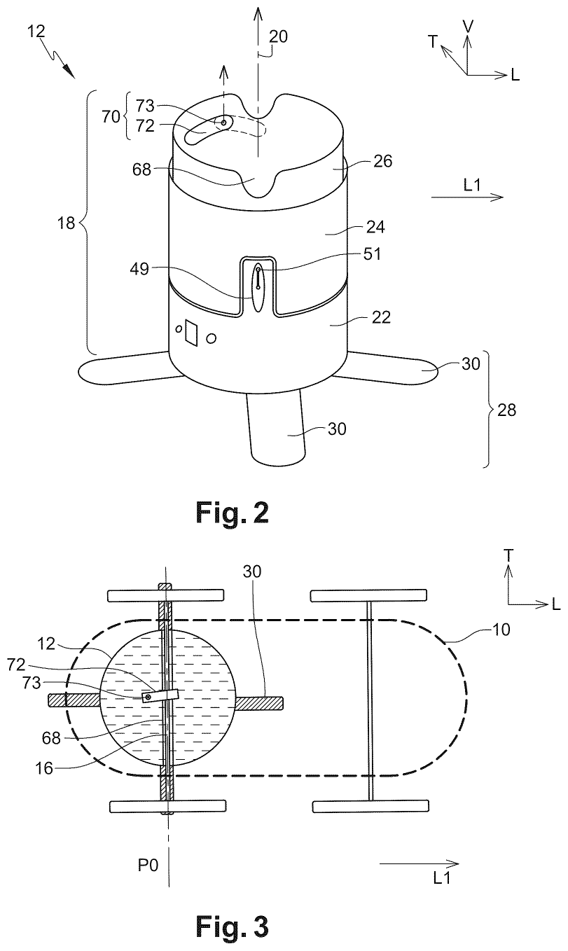

Referring to FIG. 2, the rocking device 12 comprises a housing assembly 18 extending along a main axis 20 which is vertical in the example. The main axis 20 could also be inclined to the vertical direction and form an acute angle with the V axis.

In the embodiment represented, the housing assembly 18 is cylindrical, that is to say that the generatrix of the lateral face of the housing assembly is parallel to the main axis 20. The horizontal section of the housing assembly 18 is circular. As a variant, the horizontal section of the housing could be square-shaped, triangular-shaped or of any shape, or the housing assembly could be truncated cone-shaped or pyramid-shaped.

The housing assembly 18 consists of several parts among which:
a base part 22,
a movable part 24,
a telescopic part 26.

The base part 22 is configured for placing the rocking device on the ground in a stable manner. The contact points between the base part 22 and the ground are sufficiently distributed and the center of gravity of the rocking device 12 is sufficiently low to give the rocking device 12 good stability.

The base part 22 comprises a stabilizing element 28 with respect to the ground. In the illustrated embodiment, the stabilizing element 28 comprises at least three legs 30. The legs 30 are retractable. The retractable legs 30 can be folded inwards. In an embodiment not shown, the legs 30 could be extended or retracted by sliding, for example in a telescopic manner. As a variant, the stabilizing element 28 could include a flared extension of the base part 22 or a large horizontal base.

The movable part 24 is mounted on the base part 22 so as to be movable in translation with respect to the base part 22, along the longitudinal translation direction L1.

The movable part 24 comprises:
a rest position P0, shown in FIG. 3, wherein the movable part 24 is substantially aligned with the base part 22 along the main axis 20,
at least one extreme position wherein the movable part 24 is shifted from the base part 22 along the longitudinal translation direction L1.

The at least one extreme position can either correspond to a shift forward or backward.

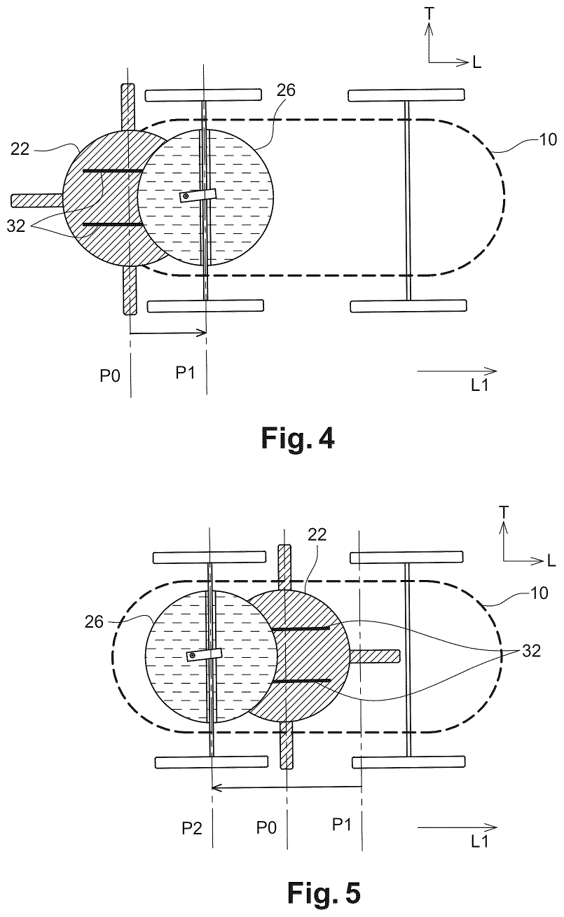

In the example illustrated in FIGS. 4 to 5, the movable part 24 comprises two extreme positions that are symmetrical with respect to the main axis 20 among which a forward extreme position P1 corresponding to the maximum forward motion, and. a backward extreme position P2 corresponding to the maximum backward motion. The movable part 24 oscillates between the forward extreme position P1 and the backward extreme position P2 according to a translation along L1.

The rest position P0 is placed between the forward extreme position P1 and the backward extreme position P2 and is equidistant from the forward extreme position P1 and the backward extreme position P2. The stroller 10 is driven by the rocking devices 12 and oscillates with the same displacement as the movable part 24.

To allow a sliding movement of the movable part 24 in relation to the base part 22, the housing assembly 18 comprises at least one rail 32, 33 extending in the longitudinal translation direction L1. Various layouts are possible as explained below.

According to a first basic layout (not shown), the rail 32, 33 is arranged in the base part 22 and a guiding part 34, 35 with a complementary shape such as a through hole is arranged in the movable part 24 in order to be able to slide along the rail 32, 33.

According to a second basic layout (not shown), the rail 32, 33 is arranged in the movable part 24 and the guiding part 34, 35 is arranged in the base part 22.

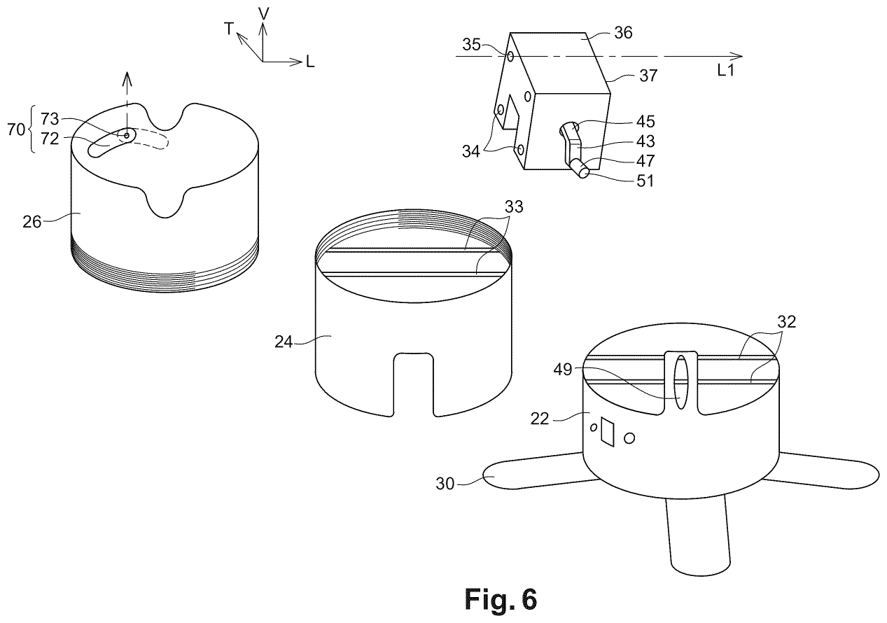

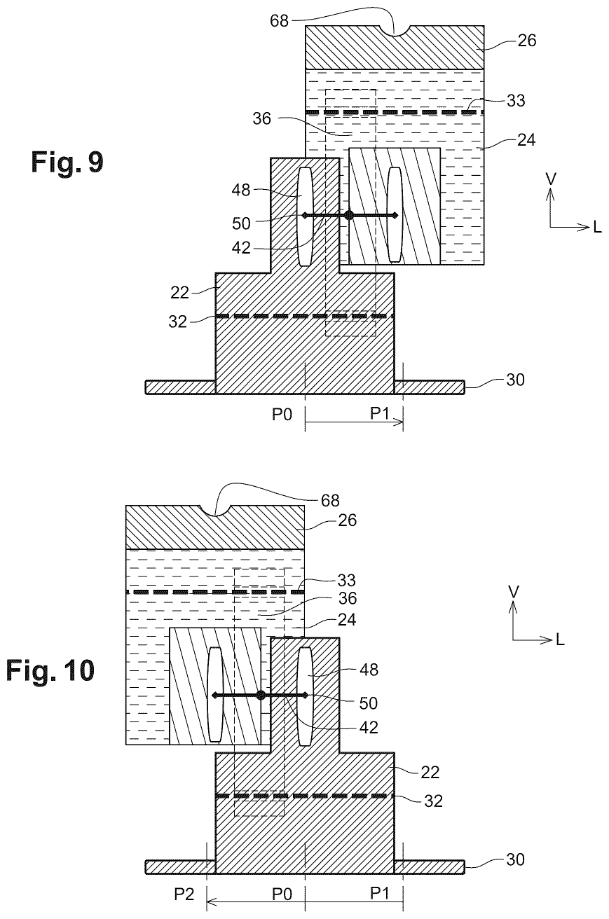

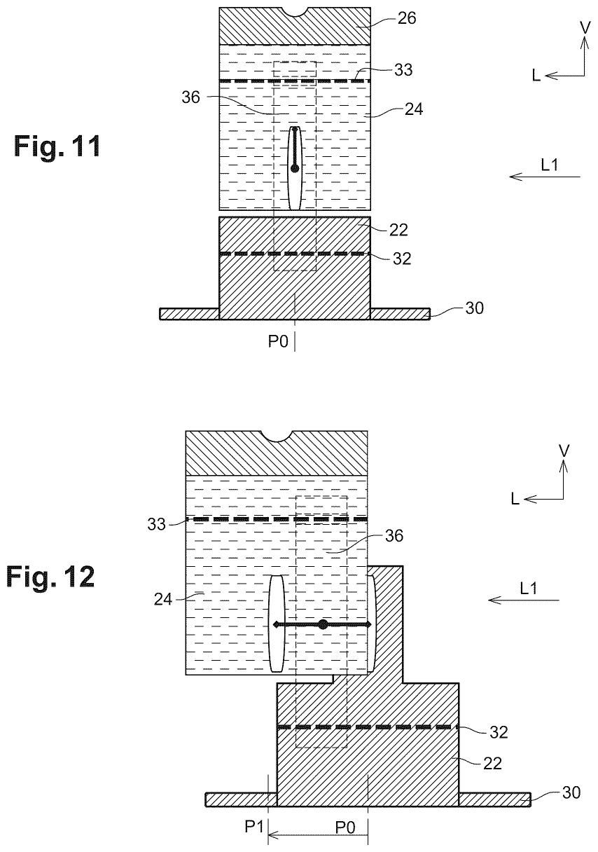

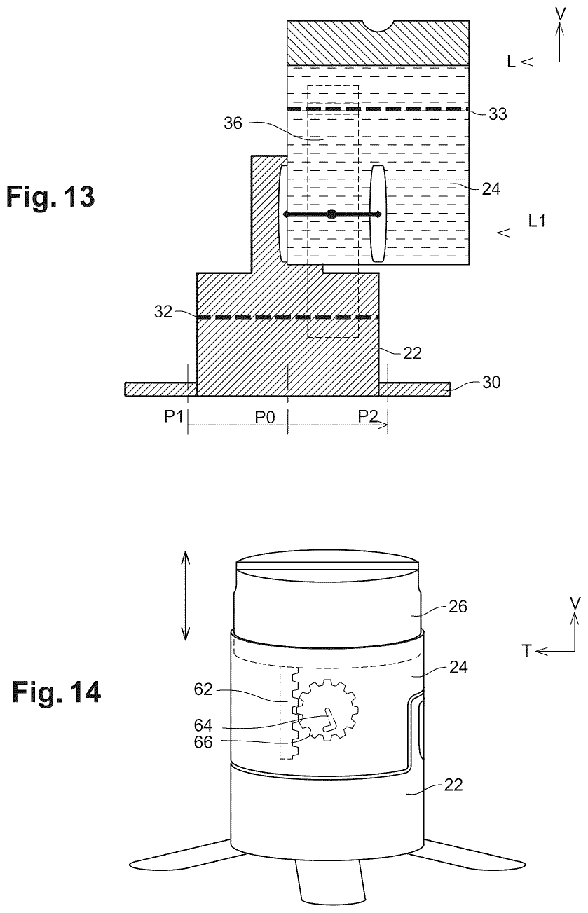

According to a more sophisticated layout shown in FIGS. 6 to 13, the housing assembly 18 comprises two stages of rails extending in the longitudinal translation direction L1 among which a first stage with two bottom rails 32 and a second stage with two top rails 33. Besides, the housing assembly 18 comprises a sliding block 37.

The sliding block 37 comprises a bottom guiding part 34 interfaced with the bottom rails 32 and a top guiding part 35 interfaced with the top rails 33. In the example, the rails 32, 33 are cylindrical rods and the guiding parts 33, 35 are cylindrical through holes.

The bottom rails 32 are arranged in the base part 22 and the top rails 33 are arranged in the movable part 24. The sliding block 37 is encapsulated in the housing assembly formed by the superposition of the base part 22 and the movable part 24. The sliding block 37 is suitable for sliding in relation to the base part 22 and to the movable part 24.

The two stages allow a larger amplitude of oscillation with a given size of housing assembly and thus allow for a more compact rocking device.

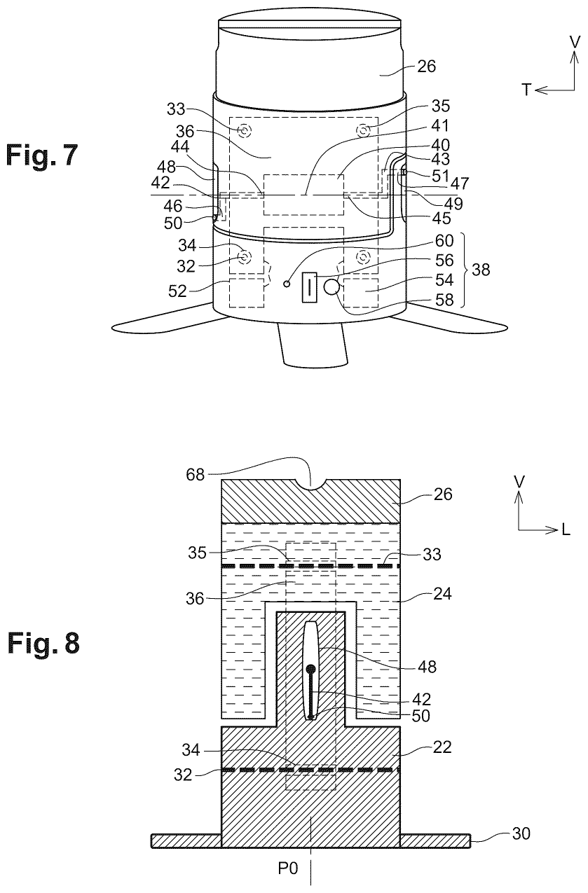

Referring to FIGS. 6 and 7, the housing assembly 18 contains an electrical drive mechanism 36 and an electrical power supply 38 providing power to the electrical drive mechanism 36.

The electrical drive mechanism 36 drives in translation the movable part 22 between the rest position and the at least one extreme position according to an oscillatory movement.

In an embodiment, the electrical drive mechanism 36 comprises a rotary electric motor 40 with a motor rotation axis 41 and at least one connecting rod 42, 43 comprising a proximal end 44, 45 connected to the electric motor 40 and a distal end 46, 47 connected to the housing assembly 18.

In the illustrated embodiment, the electrical drive mechanism 36 is located in the sliding block 37. The electrical drive mechanism 36 comprises a first connecting rod 42 and a second connecting rod 43. The first connecting rod 42 is mounted on the left-side face of the sliding block 37 and comprises a first proximal end 44 connected to the left end of the shaft of the electric motor 40. The second connecting rod 43 is mounted on the right-side face of the sliding block 37 and comprises a second proximal end 45 connected to the left end of the shaft of the electric motor 40 connected to the right end of the shaft of the electric motor 40.

The movable part 24 comprises a first slideway 48. The first slideway 48 is a vertical slot made in the left side face of the moving part 24 which is shown in FIGS. 11 to 13. The first slideway 48 has a height corresponding to twice the length of the first connecting rod 42 and is centered on the motor rotation axis 41.

The first connected rod 42 has a first distal end 46 comprising a first pin 50 inserted in the first slideway 48. The first pin 50 is arranged in the first slideway 48 in such a way that when the first connecting rod 42 is driven in rotation by the electric motor 40, the first pin 50 exerts a longitudinal push or pull on the edges of the first slideway 48 so as to drive the movable part 24 in longitudinal translation according to a back-and-forth movement. The sliding of the first pin 50 in the first slideway 48 provides a degree of freedom according to the transverse translation in order not to pass on the transverse component of the rotation movement to the movable part 24.

The base part 22 comprises a second slideway 49. The second slideway 49 is a vertical slot made in the right-side face of the base part 22 which is shown in FIGS. 8 to 10. The second slideway 49 has a height corresponding to twice the length of the second connecting rod 43 and is centered on the motor rotation axis 41. The right-side face of the base part 22 has a vertical upward protrusion comprising the second slideway 49 so that the second slideway 49 is symmetrical to the first slideway 48.

The second connected rod 43 has a second distal end 47 comprising a second pin 51 inserted in the second slideway 49. The second pin 51 is arranged in the second slideway 49 in such a way that when the second connecting rod 43 is driven in rotation by the electric motor 40, the second proximal end 45 exerts a longitudinal push or pull on the sliding block 37 so as to drive the sliding block 37 in longitudinal translation according to a back-and-forth movement.

The sliding of the second pin 51 in the second slideway 49 provides a degree of freedom according to the transverse translation in order not to pass on the transverse component of the rotation movement to the base part 22. In the example of FIGS. 6 to 13, the longitudinal displacement of the movable part 24 in relation to the base part 22 is equal to the sum of the length of the first connecting rod 42 and the length of the second connecting rod 43.

In the illustrated embodiment, the motor rotation axis 41 is transversal, and the slideways 48, 49 are vertical. In another embodiment, the motor rotation axis 41 could be vertical, and the slideways be transversal.

More generally, the transformation of the rotational movement of the electric motor 40 into the translation movement of the movable part 24 can be achieved by a conventional connecting rod-crank system. For example, the joints at the two ends of the connecting rod can be pivotal or ball-and-socket joints.

In FIGS. 6 to 13, the electric motor 40 is located in the sliding block 37. In another embodiment, the electric motor 40 can be located in the base part 22 and the distal end of the connecting rod can be articulated on the movable part 24. Still in another embodiment, the electric motor 40 can be located in the movable part 24 and the distal end of the connecting rod can be articulated on the base part 22.

In an alternative embodiment, the electrical drive mechanism 36 comprises another type of electric actuator such as an electric piston, a rack and pinion electric system or a worm screw electric system.

The electrical drive mechanism 36 can also comprises a control system 52 controlling the operation of the electric motor 40. The control system 52 may include a programming system including various control parameters such as:
duration of the oscillatory movement,
the speed of the longitudinal displacement,
the amplitude of the longitudinal displacement.

The control system 52 may also include a Human-Machine Interface and a remote-control system with connection means to the control system 52.

The power supply 38 comprises:
a battery 54 to provide power to the electrical drive mechanism 36 without the need to connect it to the grid,
an electrical plug 56 to recharge the battery 54 or to supply power directly to the electrical drive mechanism 36 when no battery is present,
an on/off switch 58 in order to turn on or turn off the supply of the electrical drive mechanism 36, and
an indicator light 60 to indicate whether the electrical drive mechanism is powered.

Referring to FIG. 14, the telescopic part 26 is mounted so as to be able to slide with respect to the movable part 24 along the main axis 20. In the illustrated embodiment, the telescopic part 26 comprises at least one vertically extending toothed rail 62.

The movable part 24 comprises at least one crank 64 driving in rotation a toothed wheel 66 cooperating with the toothed rail 62 to allow an adjustment of the height of the telescopic part 26. The toothed wheel 66 is mounted so as to be able to rotate around an axis orthogonal to a lateral face of the movable part 24 and is arranged in the toothed rail 62 so as to make the telescopic part 26 slide vertically with respect to the movable part 24.

The telescopic part 26 could be mounted in another way on the movable part 24. For example, by means of a thread or an accordion system or another telescopic mechanism also allowing height adjustment of the telescopic part 26.

The telescopic part 26 comprises the gripping means 14. The gripping means 14 comprise a slot 68 to receive a portion of the stroller 10 such as the stroller axle 16.

The gripping means 14 also comprise retaining means 70 for holding the stroller axle 16 in the slot 68. The retaining means 70 comprise a cleat 72 and the cleat 72 is pivotally movable about a vertical cleat axis 73 between a retracted position and a retaining position. The cleat 72, when pivoted above the slot 68 blocks and retains the stroller axle 16 in the slot 68 in order to secure the rocking device 12 to the stroller axle 16.

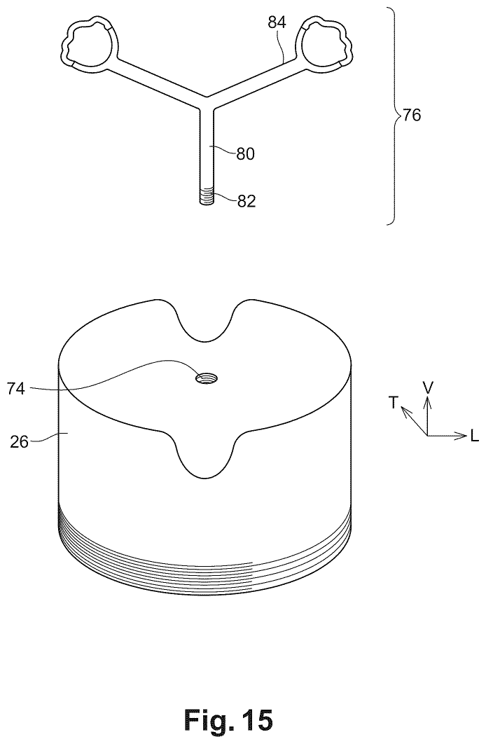

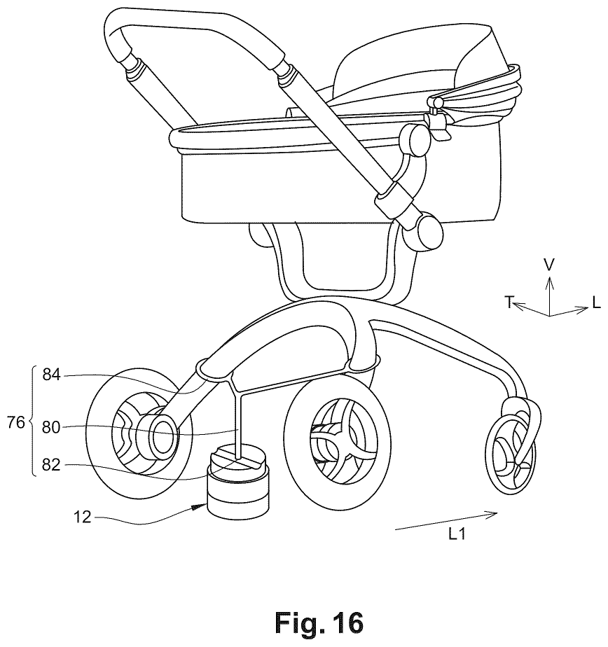

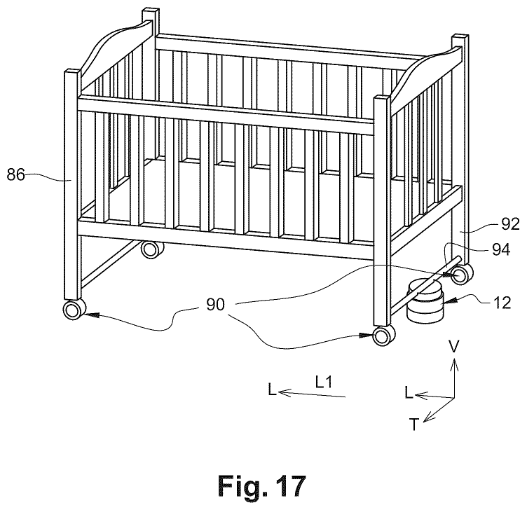

In an embodiment shown in FIGS. 15 and 16, the gripping means 14 comprise a nut 74 for attaching an attachment element 76 to the frame of a stroller 10. This attachment element 76 may be used as an alternative to the cleat 72 in order to secure the rocking device 12 to the stroller 10 when the frame structure of the stroller 10 is not compatible with an attachment with the cleat 72. As a variant, the attachment element 76 could be clipped on the telescopic part 26 or fixed by means of a pinning system.

FIG. 16 illustrates a stroller 10 equipped with a kit comprising the rocking device 12 and the attachment element 76.

The attachment element 76 here comprising at least one arm 80 comprising a threaded end 82 adapted to be screwed into the nut 74. The arm 80 has a Y shape and the threaded end 82 is located at the foot of the Y. The Y-shaped arm 80 has two other peripheral ends 84 that are configured to grip a section of the stroller frame. In the example, the peripheral ends are fixed to the two rear legs of the stroller 10.

In a variant, the arm 80 could only have a single peripheral end 84 gripping a central part of the chassis of the stroller 10. The peripheral ends 84 can be terminated by clamps, straps, suction cups or other gripping elements.

FIG. 17 illustrates another use case in which a crib 86 is equipped with:
a set of wheels 90, each wheel 90 being adapted to be fixed under a foot 92 of the crib 86 so as to make the crib 86 translationally mobile in the longitudinal direction, and
a rocking device 12 fixed to the crib 86.

The crib 86 has a crossbar 94 at the rear of the crib 86 connecting the lower ends of the feet 92. The crossbar 94 is positioned in the slot 68 of the gripping means 14 and is retained by the cleat 72 in the slot 68. In an operating state of the device, the rocking device 12 imparts an oscillatory movement from back to front to the crib 86 along the longitudinal translation direction L1.

### LEGEND

10 stroller
12 rocking device
14 gripping means
16 stroller axle
18 housing assembly
20 main axis
22 base part
24 movable part
26 telescopic part
28 stabilizing element
30 leg
32 bottom rail
33 top rail
34 bottom guiding part
35 top guiding part
36 electrical drive mechanism
37 sliding block
38 electrical power supply
40 electric motor
41 motor rotation axis
42 first connecting rod
43 second connecting rod
44 first proximal end
45 second proximal end
46 first distal end
47 second distal end
48 first slideway
49 second slideway
50 first pin
51 second pin
52 control system
54 battery
56 electrical plug
58 on/off switch
60 indicator light
62 toothed rail
64 crank
66 toothed wheel
68 slot
70 retaining means
72 cleat
73 cleat axis
74 nut
76 attachment element
80 arm
82 threaded end
84 peripheral end
86 crib
90 wheel
92 foot
94 crossbar

1. A rocking device suitable for rocking a stroller, said rocking device comprising a housing assembly which contains an electrical drive mechanism and an electrical power supply, and which is provided with gripping means suitable to grip a portion of a stroller,
said housing assembly consisting of at least two parts extending along a main axis:
a base part for placing the rocking device on the ground in a stable manner,
a movable part which is mounted on the base part so as to be movable with respect to the base part, along a longitudinal translation direction (L1) which is substantially perpendicular to the main axis, according to an oscillatory movement imparted by the electrical drive mechanism,
said movable part comprising:
a rest position (P0) wherein the movable part is substantially aligned with the base part along the main axis,
at least one extreme position (P1, P2) wherein the movable part is shifted from the base part along the longitudinal translation direction,
such that said oscillatory movement provoke alternate displacement of the movable part between the rest position (P0) and the at least one extreme position (P1, P2).

2. A rocking device according to claim 1 in which the housing assembly comprises at least one rail extending in the longitudinal translation direction allowing a sliding movement of the movable part in relation to the base part.

3. A rocking device according to claim 2 in which the housing assembly comprises a sliding block and two stages of rails extending in the longitudinal translation direction (L1) among which:
a first stage with two bottom rails arranged in the base part, the sliding block comprising a bottom guiding part interfaced with the bottom rails, and
a second stage with two top rails arranged in the movable part, the sliding block comprising a top guiding part interfaced with the top rails.

4. A rocking device according to claim 1 in which the electrical drive mechanism comprises:
a rotary electric motor, and
a connecting rod comprising a proximal end connected to the motor and a distal end connected to the housing assembly.

5. A rocking device according to claim 4 in which the housing assembly comprises a slideway and the distal end of the connected rod comprises a pin inserted in the slideway.

6. A rocking device according to claim 5 in which:
the motor rotation axis is transversal, and
the slideway is vertical.

7. A rocking device according to claim 1 in which the gripping means comprise a slot extending transversally across the top of the housing to receive a portion of the stroller.

8. A rocking device according to claim 7 in which the gripping means also comprise retaining means comprising a cleat pivotally movable about a vertical cleat axis between a retracted position and a retaining position in which the cleat is pivoted above the slot in order to secure the rocking device to the stroller.

9. A rocking device according to claim 1 in which the gripping means comprise a nut for attaching an attachment element to the frame of a stroller.

10. A rocking device according to claim 1 in which the housing assembly also comprises a telescopic part, the gripping means being mounted on the telescopic part.

11. A rocking device according to claim 10 in which the telescopic part is mounted so as to be able to slide with respect to the movable part along the main axis.

12. A rocking device according to claim 11 in which:
the telescopic part comprises at least one vertically extending toothed rail,
the movable part comprises at least one crank driving in rotation a toothed wheel cooperating with the toothed rail.

13. A rocking device according to claim 1 in which the base part comprises a stabilizing element with respect to the ground.

14. A rocking device according to claim 13 in which the stabilizing element comprises at least three legs.

15. A rocking device according to claim 14 in which the legs are retractable.
